(19) United States
(12) Patent Application Publication
(10) Pub. No.: US 2008/0297728 A1
(43) Pub. Date: Dec. 4, 2008

(54) Color Projector with a Compact Optical Integrator and Method of Projecting an Image Using the Same

(75) Inventors: Bart Salters, Eindhoven (NL); Marcellinus Petrus Carolus Michael Krijn, Eindhoven (NL); Oscar Hendrikus Willemsen, Den Bosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,870

(22) PCT Filed: Nov. 28, 2006
(86) PCT No.: PCT/IB06/54490

§ 371 Date: Jun. 2, 2008

Related U.S. Application Data
(60) Provisional application No. 60/741,554, filed on Dec. 1, 2005.

(51) Int. Cl. H04N 9/31; G03B 21/14

(52) U.S. Cl. 353/20; 353/31; 353/121

(57) ABSTRACT

In the color projector (200, 300, 400), a light source (220) produces first, second, and third colored light beams. An optical integrator (230, 330, 430) integrates the first colored light beam, the second colored light beam, and the third colored light beam. The integrated first colored light beam, second colored light beam, and third colored light beam are modulated by first (252), second (254), and third (256) light modulators, respectively, producing first, second, and third colored images. An optical synthesizer (260) combines the first, second, and third colored images to form a synthesized color image, and a projection lens (180) projects the synthesized color image. The optical integrator (230, 330, 430) includes a polarizing beam splitter (240, 441) in an optical path of at least one of the first, second, and third colored light beams to increase the effective integration length of the corresponding colored light beam.

This invention pertains to color projectors and methods of projecting color images, more particularly, to a color projector and method of projecting a color image employing a compact optical integrator to increase the uniformity of light to be imaged and projected.

A color projector can typically be divided into three major components: an illumination system, including a light source and illumination optics; an image generation system, including one or more light modulators; and a projection system including projection optics. Meanwhile, the demand for color projectors for displaying color images is becoming increasingly widespread. Driving this demand are reductions in the cost, size, and weight of color projectors, as well as improvements in performance.

One of the driving factors in the size, weight, and performance of a color projector is the illumination system, and particularly the light source. Typically, color projectors have employed an ultrahigh-pressure (UHP) mercury lamp as a light source. However, there is a practical limitation to making a small, lightweight, and low power illumination system including a UHP light source can be made.

Accordingly, it would be desirable to provide a color projector that can employ an alternative illumination system that can reduce the size and weight of the overall color projector. It would also be desirable to provide a color projector with a compact, high-performance, illumination system. It would be further desirable to provide a method of projecting an image using such a color projector. The present invention is directed to addressing one or more of the preceding concerns.

In one aspect of the invention, a color projector comprises: a light source adapted to produce first, second, and third colored light beams; an optical integrator adapted to integrate the first colored light beam, to integrate the second colored light beam, and to integrate the third colored light beam; first, second, and third light modulators, each adapted to receive a corresponding one of the integrated first, second, and third colored light beams and adapted to produce therefrom corresponding first, second, and third colored images; an optical synthesizer adapted to combine the first, second, and third colored images to form a synthesized color image; and a projection lens adapted to project the synthesized color image, wherein the optical integrator includes a polarizing beamsplitter in an optical path of at least one of the first, second, and third colored light beams.

In another aspect of the invention, a method of projecting an image comprises: providing first, second, and third colored light beams; integrating the first colored light beam, integrating the second colored light beam, and integrating the third colored light beam; modulating the integrated first light beam, the integrated second light beam, and the integrated third light beam to produce corresponding first, second, and third colored images; and combining the first, second, and third colored images to form a synthesized color image, wherein integrating the first colored light beam, integrating the second colored light beam, and integrating the third colored light beam includes providing at least one of the first, second, and third colored light beams to a polarizing beamsplitter.

Further and other aspects will become evident from the description to follow.

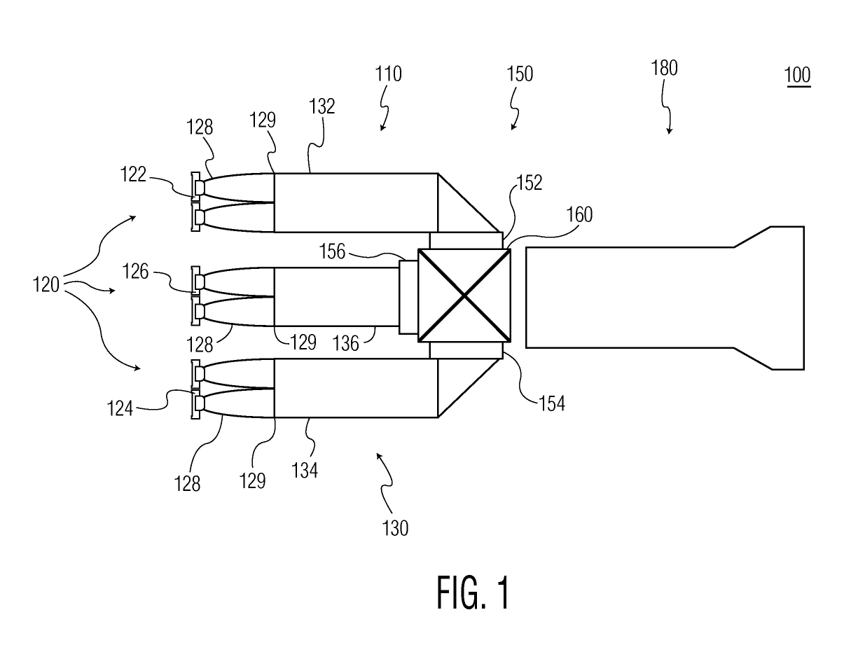

FIG. 1 illustrates one embodiment of a color projector;

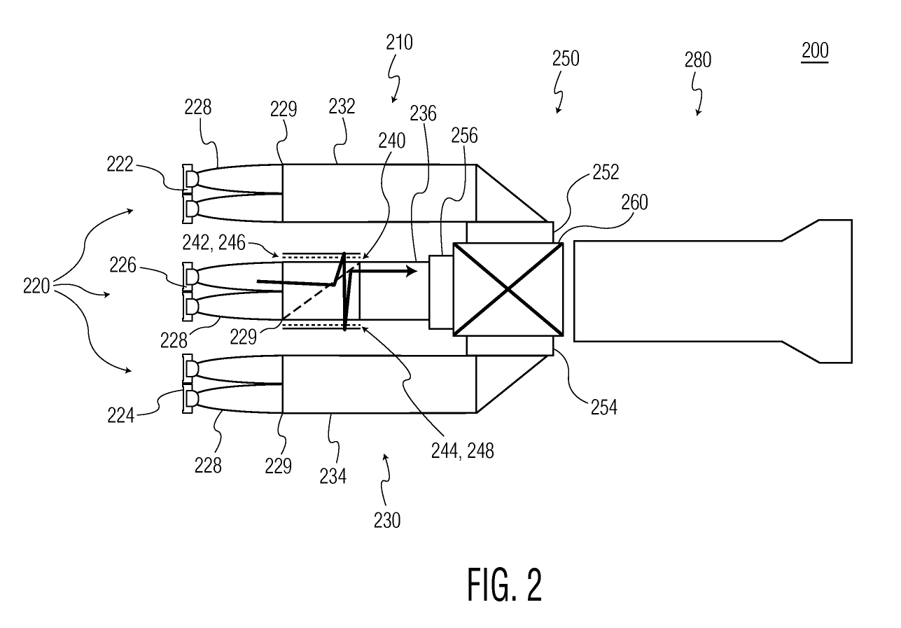

FIG. 2 illustrates another embodiment of a color projector;

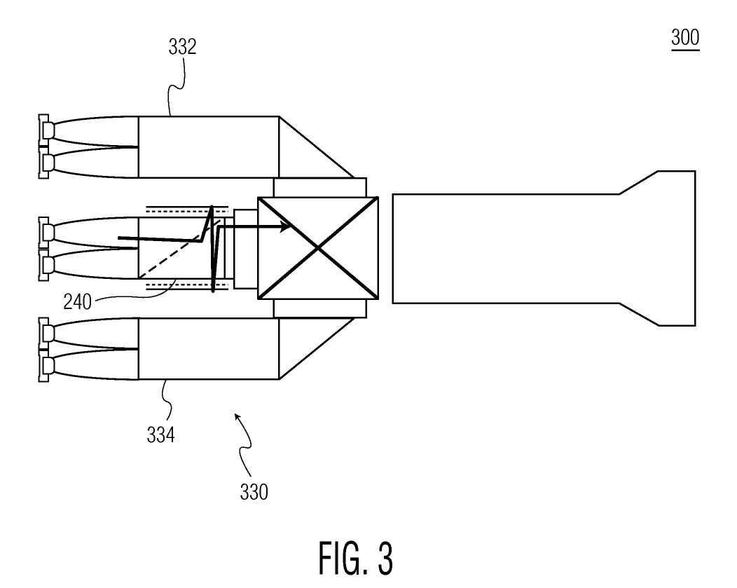

FIG. 3 illustrates yet another embodiment of a color projector;

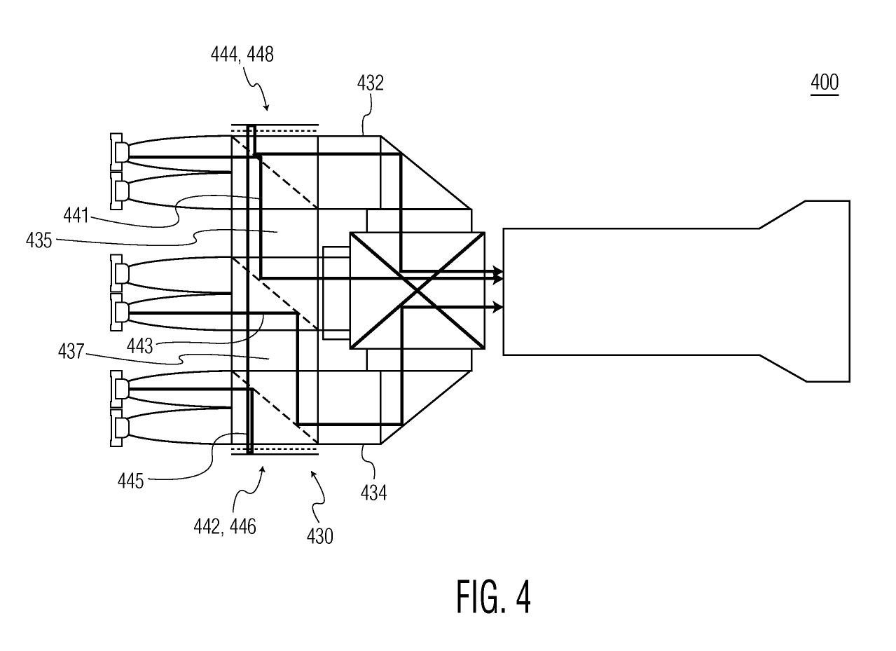

FIG. 4 illustrates still another embodiment of a color projector.

FIG. 1 illustrates pertinent parts of a color projector 100, including illumination system 110, image generator 150, and projection system 180.

Illumination system 110 includes light source 120 and optical integrator 130.

Light source 120 includes first, second, and third light emitting diodes (LEDs) 122, 124, and 126, collimators 128, and polarizers 129. Although the embodiment of FIG. 1 includes a pair of first LEDs 122, a pair of second LEDs 124, and a pair of third LEDs 126, alternatively, light source 120 may include only a single first LED 122, a single second LED 124, and a single third LED 126. First, second, and third LEDs 122, 124, and 126 emit colored light having three different colors (first, second, and third colors, respectively). Beneficially, first, second, and third LEDs 122, 124, and 126 emit red light, blue light, and green light, respectively. Collimators 128 collect light from the first, second, and third LEDs 122, 124, and 126 and collimate the light into first, second, and third colored light beams. Polarizers 129 linearly polarize the light in a desired polarization for proper operation of image generator 150.

Meanwhile, optical integrator 130 includes first, second, and third integrating light rods 132, 134 and 136. Beneficially, each integrating light rod 132, 134, 136 is a piece of glass of optical quality having a rectangular cross-section. Beneficially, the cross-section may have an aspect ratio of 16:9 or 4:3. However, integrating light rods 132, 134, 136 could be made of plastic, or any other suitable optically transparent material, instead of glass.

Image generator 150 includes first, second, and third light modulators 152, 154, and 156, and optical synthesizer 160. Beneficially, first, second, and third light modulators 152, 154, and 156 are each liquid crystal display (LCD) devices, in particular, transmissive LCD light modulator panels. First, second, and third light modulators 152, 154, and 156 each receive a corresponding image signal from electronics (not shown) in the color projector 100. Beneficially, optical synthesizer 160 comprises a recombination cube, also known as an X-cube.

Projection system 180 includes at least one projection lens.

In operation, first, second, and third LEDs 122, 124, and 126 operate with collimators 128 to generate first, second, and third colored light beams respectively. Beneficially, first, second, and third colored light beams are red, green, and blue colored light beams. The first, second, and third colored light beams are provided to the light integrator 130, in particular to first, second, and third integrating light rods 132, 134 and 136, respectively. First, second, and third integrating light rods 132, 134 and 136 integrate, or mix, the first, second, and third colored light beams, respectively, to produce integrated first, integrated second, and integrated third colored light beams, respectively. First, second, and third light modulators 152, 154 and 156, each receive a corresponding one of the integrated first, second, and third colored light beams. First, second, and third light modulators 152, 154 and 156 also receive a corresponding image signal from electronics (not shown) in the color projector 100, and in response thereto modulate the integrated first, integrated second, and integrated third colored light beams, respectively, to produce therefrom corresponding first, second, and third colored images.

Optical synthesizer 160 combines the first, second, and third colored images and outputs a synthesized color image to projection system 180 which projects the color image.

In the color projector 100 the light ‘path’ for each colored light beam includes an integrating light rod which ‘mixes’ the colored light to produce a more uniform intensity distribution and thereby provide a uniform illumination of the light modulators (LCD panels). Crucially, the length of this integrating light rod determines the performance: the longer the integrating light rod (i.e., the longer the optical path length), the better the uniformity of the integrated colored light beam. However, a long integrating light rod does not fit very nicely into a small, compact, lightweight, color projector. This effect is especially visible in the green channel. Due to the construction of a standard optical synthesizer (recombination cube), the green channel is always in the middle (i.e., the third colored light beam). As a consequence, the integrating light rod for the green colored light beam is shorter than the integrating light rods for the red and blue colored light beams. Disadvantageously, it is also well known that in a white picture most lumens are in the green light. Hence non-uniformities are more prone to be visible in the green channel. On average, in normal television pictures, or DVD movies, or actually any “normal” video content, it will generally hold true that most lumens will be in the green channel.

FIG. 2 illustrates pertinent parts of a color projector 200 that at least partially addresses these concerns. Color projector 200 includes illumination system 210, image generator 250, and projection system 280.

Illumination system 210 includes light source 220 and optical integrator 230. Light source 220 includes first, second, and third light emitting diodes (LEDs) 222, 224, and 226 collimators 228, and polarizers 229. Although the embodiment of FIG. 2 includes a pair of first LEDs 222, a pair of second LEDs 224, and a pair of third LEDs 226, alternatively, light source 220 may include only a single first LED 222, a single second LED 224, and a single third LED 226, or more than two LEDs 222, 224, 226, each. First, second, and third LEDs 222, 224, and 226 emit colored light beams having three different colors (first, second, and third colors, respectively). Beneficially, first, second, and third LEDs 222, 224, and 226 emit red light, blue light, and green light, respectively. Collimators 228 collect light from the first, second, and third LEDs 222, 224, and 226 and collimate the light into first, second, and third colored light beams. Polarizers 229 linearly polarize the light in a desired polarization for proper operation of image generator 250 and the polarizing beamsplitter 240, as discussed below.

Optical integrator 230 includes first, second, and third integrating light rods 232, 234 and 236. Beneficially, each integrating light rod 232, 234, 236 is a piece of glass of optical quality having a square cross-section. However, integrating light rods 232, 234, 236 could be made of plastic, or any other suitable optically transparent material, instead of glass.

However, in contrast to color projector 100, in color projector 200 optical integrator 230 also includes a polarizing beamsplitter 240 in the optical path of the third colored light beam (beneficially, the green colored light beam). Also, the length of third integrating light rod 236 is less than the lengths of first and second integrating light rods 232 and 234. The general operation of a polarizing beamsplitter is well-known to one skilled in the art, and so will not be explained here. Optical integrator 230 further includes first and second quarter-wave plates 242, 244 and first and second mirrors 246, 248. The function of polarizing beamsplitter 240, first and second quarter-wave plates 242, 244 and first and second mirrors 246, 248 in optical integrator 230 and color projector 200 will be explained in detail below.

Image generator 250 includes first, second, and third light modulators 252, 254, and 256, and optical synthesizer 260. Beneficially, first, second, and third light modulators 252, 254, and 256 are each liquid crystal display (LCD) devices, in particular, transmissive LCD light modulator panels. First, second, and third light modulators 252, 254, and 256 each receive a corresponding image signal from electronics (not shown) in the color projector 200. Beneficially, optical synthesizer 260 comprises a recombination cube, also known as an X-cube.

Projection system 280 includes at least one projection lens.

In general, the operation of color projector 200 is the same as the operation of color projector 100, except for the operation of optical integrator 230. Accordingly, in order to avoid redundancy, only the differences in operation between color projector 200 and color projector 100, namely the operation of optical integrator 230, will be explained now.

The third colored light beam from third LED(s) (beneficially, green LED(s)) 226 is provided to the polarizing beamsplitter 240 of optical integrator 230. Due to polarizer 229 in between collimator 228 and polarizing beamsplitter 240, only light with the correct polarization direction will reach polarizing beamsplitter 240. Polarizing beamsplitter 240 is positioned such that the third colored light beam is reflected towards one of the sidewalls, preferably the one on the long axis of optical integrator 230. Here first quarter-wave plate 242 and first mirror 246 are positioned. Care is taken that the extraordinary axis of first quarter-wave plate 242 is rotated 45 degrees with respect to the polarization direction of the incoming light. First quarter-wave plate 242 is traversed twice, and in combination with the mirror 246 the polarization of the third colored light beam is changed from horizontal to vertical (or vice versa). Meanwhile, polarizing beamsplitter 240 is transparent for light in this polarization direction. At the other sidewall of polarizing beamsplitter 240, an identical construction is placed, i.e., second quarter-wave plate 244 and second mirror 248 are positioned. As the third colored light beam passes through second quarter-wave plate 244, is reflected by second mirror 248, and passes back again through second quarter-wave plate 244, the polarization direction is reversed again. The light beam again impinges on polarizing beamsplitter 240. However with the polarization reversed by second quarter-wave plate 244 and second mirror 248, polarizing beamsplitter 240 reflects the third colored light beam toward third light modulator 256, the third colored light beam first being further integrated by third integrating light rod 236.

Accordingly, by providing polarizing beamsplitter 240, the integration length for the third colored light beam (e.g., the green light beam) is effectively roughly tripled. This in turn substantially enhances the uniformity of the green light (which is the most critical light) at the expense of a few percent loss in intensity due to absorption of the mirror, but without an increase in the size of color projector 200 compared to color projector 100.

It is understood that in addition to (or instead of) placing a polarizing beamsplitter in the optical path of the third colored light beam (e.g., in the green channel) in the optical integrator, polarizing beamsplitters can also be applied in the optical paths of the first (e.g., red) colored light beam, and/or the second (e.g., blue) colored light beam in the optical integrator. Also, more than one polarizing beamsplitter can be employed for the optical path of a single color. The trade-off of cost versus performance increase will determine whether this is desirable.

As explained above, a polarizing beamsplitter can be included in an optical integrator to obtain an increase in performance of the color projector without an increase in the size. However, alternatively, the size (length) of the color projector can be reduced, as shown below with respect to FIG. 3.

FIG. 3 illustrates pertinent parts of another embodiment of a color projector 300 having an optical integrator 300 that includes a polarizing beamsplitter 240. Color projector 300 is similar to color projector 200, and operates essentially the same, except that optical integrator 330 does not include a third integrating light rod in the optical path of the third colored light beam, and the lengths of first and second integrating light rods 332 and 334 have been reduced. According to this embodiment, the size (length) of color projector 300 can be reduced compared with color projector 100, while the effective integration path of the third colored light beam (e.g., the green colored light beam) still can be increased somewhat compared with color projector 100.

FIG. 4 illustrates pertinent parts of another embodiment of a color projector 400. In general, the construction and operation of color projector 400 is the same as the construction and operation of color projector 200, except for the construction and operation of optical integrator 430, and a change in the positional rearrangement of first, second, and third LEDs 222, 224, and 226, shown in FIG. 4, to accommodate the operation of optical integrator 430. Accordingly, in order to avoid redundancy, only the differences in construction and operation between color projector 200 and color projector 400, namely the construction and operation of optical integrator 430, will be explained now.

Optical integrator 430 includes first and second integrating light rods 432 and 434, first second and third polarizing beamsplitters 441, 443, and 445, first and second quarter-wave plates 442, 444, first and second mirrors 446, 448, and first and second optically transparent (e.g., glass) members 435 and 437. Beneficially, each integrating light rod 432 and 434 is a piece of glass of optical quality having a rectangular cross-section.

Optical integrator 430 operates as follows. The first colored light beam (e.g., the red colored light beam) in order, is reflected by third polarizing beamsplitter 445, passes through first quarter-wave plate 442, is reflected by first mirror 446, passes back through first quarter-wave plate 442, passes through third polarizing beamsplitter 445, passes through second polarizing beamsplitter 443, passes through the first polarizing beamsplitter 441, passes through second quarter-wave plate 444, is reflected by second mirror 448, passes back through second quarter-wave plate 444, and is reflected by first polarizing beamsplitter 441 toward first light modulator 252. Meanwhile, the second colored light beam (e.g., blue colored light beam), in order, is reflected by second polarizing beamsplitter 443, and is reflected by third polarizing beamsplitter 445 toward second light modulator 254. Also, the third colored light beam (e.g., the green colored light beam) is reflected by first polarizing beamsplitter 441, and is then reflected by second polarizing beamsplitter 443 toward third light modulator 256. First and second optically transparent members 435 and 437, disposed respectively in an optical path between first polarizing beamsplitter 441 and second polarizing beamsplitter 443, and in an optical path between second polarizing beamsplitter 443 and the third polarizing beamsplitter 445, serve to conserve the light in the first, second, and third colored light beams as they pass between the various polarizing beamsplitters.

In color projector 400 the integration path lengths of the first, second, and third colored light beams are not identical. However, this is not important so long as each of the integration path lengths is sufficient to make the light beams uniform. That is, once the light distribution of a light beam within an optical integrator becomes uniform, it will remain that way as it travels any remaining length of the optical integrator. Advantageously, the vertical path and the use of three polarizing beamsplitters 441, 443, and 445 in the optical integrator 430 of color projector 400 provide a much longer path for the three colored light beams than in the color projector 100, thus significantly improving the uniformity of the light intensity distribution of the integrated colored light beams. This in turn enhances the quality of the images projected by color projector 400.

It is understood that several different arrangements of colors and polarizing beamsplitters are possible, and the embodiment shown in FIG. 4 and described above is exemplary in nature.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A color projector, comprising:
a light source adapted to produce first, second, and third colored light beams;
an optical integrator adapted to integrate the first colored light beam, to integrate the second colored light beam, and to integrate the third colored light beam;
first, second, and third light modulators, each adapted to receive a corresponding one of the integrated first, second, and third colored light beams and adapted to produce therefrom corresponding first, second, and third colored images;
an optical synthesizer adapted to combine the first, second, and third colored images to form a synthesized color image; and
a projection lens adapted to project the synthesized color image,
wherein the optical integrator includes a polarizing beamsplitter in an optical path of at least one of the first, second, and third colored light beams.

2. The color projector of claim 1, where the light source comprises first, second, and third light emitting diodes (LEDs) emitting the first, second, and third colored light beams, respectively.

3. The color projector claim 1, wherein one of the colored light beams is a green light beam and the polarizing beamsplitter of the optical integrator is in the optical path of the green light beam.

4. The color projector claim 1, wherein the polarizing beamsplitter of the optical integrator is in the shortest optical path of the first, second, and third colored light beams.

5. The color projector of claim 1, wherein the optical integrator comprises:
a first integrating light rod adapted to integrate the first colored light beam;
a second integrating light rod adapted to integrate the second colored light beam; and
the polarizing beamsplitter adapted to integrate the third colored light beam.

6. The color projector of claim 5, wherein the optical integrator further comprises first and second quarter-wave plates and first and second mirrors.

7. The color projector of claim 5, where the third colored light beam is a green light beam.

8. The color projector of claim 5 wherein the optical integrator further comprises a third integrating light rod disposed in an optical path of the third colored light beam.

9. The color projector of claim 1, wherein the optical integrator further comprises a second polarizing beamsplitter.

10. The color projector of claim 9, further comprising:
a third polarizing beamsplitter;
a first optically transparent member disposed in an optical path between the first polarizing beamsplitter and the second polarizing beamsplitter; and
a second optically transparent member disposed in an optical path between the second polarizing beamsplitter and the third polarizing beamsplitter.

11. The color projector of claim 1, wherein at least two different colored light beams pass through the polarizing beamsplitter.

12. The color projector of claim 1, wherein the first, second, and third light modulators are all liquid crystal devices.

13. A method of projecting an image, comprising:
providing first, second, and third colored light beams;
integrating the first colored light beam, integrating the second colored light beam, and integrating the third colored light beam;
modulating the integrated first light beam, the integrated second light beam, and the integrated third light beam to produce corresponding first, second, and third colored images; and
combining the first, second, and third colored images to form a synthesized color image,
wherein integrating the first colored light beam, integrating the second colored light beam, and integrating the third colored light beam includes providing at least one of the first, second, and third colored light beams to a polarizing beamsplitter.

14. The method of claim 13, wherein the first, second, and third colored light beams are provided by first, second, and third light emitting diodes, respectively.

15. The method of claim 13, wherein the at least one colored light beam is a green light beam.

16. The method of claim 13, wherein integrating the first colored light beam includes passing the first colored light beam through a first integrating light rod, wherein integrating the second colored light beam includes passing the second colored light beam through a second integrating light rod, and wherein integrating the third colored light beam includes passing the third colored light beam through the polarizing beamsplitter.

17. The method of claim 16, where the third colored light beam is a green light beam.

18. The method of claim 16, wherein integrating the third colored light beam comprises, in order:
reflecting the third colored light beam from the polarizing beamsplitter;
passing the third colored light beam through a first quarter-wave plate;
reflecting the third colored light beam from a first mirror;
passing the third colored light beam back through the first quarter-wave plate;
passing the third colored light beam through the polarizing beamsplitter;
passing the third colored light beam through a second quarter-wave plate;
reflecting the third colored light beam by a second mirror;
passing the third colored light beam back through the second quarter-wave plate; and
reflecting the third colored light beam by the polarizing beamsplitter toward a third light modulator.

19. The method of claim 16, wherein integrating the third colored light beam further comprises passing the third colored light beam though a third integrating light rod.

20. The method of claim 13, wherein integrating the first colored light beam, includes providing the first colored light beam to the first polarizing beamsplitter, wherein integrating the second colored light beam includes providing the second colored light beam to a second polarizing beamsplitter, and wherein integrating the third colored light beam includes providing the third colored light beam to a third polarizing beamsplitter.
